(19) United States
(12) Patent Application Publication
(10) Pub. No.: US 2014/0058714 A1
(43) Pub. Date: Feb. 27, 2014

(54) DYNAMIC CONFIGURABLE CLINICAL ANALYSIS

(71) Applicant: Robert BOYER, Longmont, CO (US)

(72) Inventor: Robert BOYER, Longmont, CO (US)

(73) Assignee: NELLCOR PURITAN BENNETT LLC, Boulder, CO (US)

(21) Appl. No.: 13/595,804

(22) Filed: Aug. 27, 2012

(51) Int. Cl. G06G 7/60

(52) U.S. Cl. 703/11

(57) ABSTRACT

A patient monitoring system includes monitoring service that receives parameter values from a number of data sources. A status model manager facilitates creation of a clinical status model that includes conditions defining relationships between parameters and thresholds. The status model manager evaluates the clinical status model based on the parameter values to determine a clinical status of a patient.

### TECHNICAL FIELD

The present disclosure relates generally to computing technology used in patient monitoring and evaluation.

### BACKGROUND

Clinicians often make decisions based on input from multiple sources and analysis of not only multiple patient parameters, but also of relationships between parameters and parameter changes over time. Often, such analysis involves determining whether parameters, parameter trends, and/or parameter relationships, which may have varying levels of significance to the analysis, satisfy conditions (e.g., thresholds, ranges, and the like). Protocols and procedures associated with such decisions are continually evolving as new research studies define and/or refine parameter relationships to improve patient outcomes. Some conventional medical devices such as, for example, multi-parameter patient monitors, are hardcoded to perform some of these analyses based on current values of parameters collected by the device. These conventional devices generally lack the ability to perform analysis of parameters from other sources or historical values of parameters and typically do not allow a clinician to update, configure or modify the analysis procedures.

### SUMMARY

Embodiments of the disclosure relate to technologies that facilitate determining a clinical status of a patient. Aspects of embodiments include creating a clinical status model that is at least partially configurable by a user. In embodiments, the clinical status model includes one or more conditions associated with one or more parameters. A condition may include a relationship between one or more parameters and one or more target values, thresholds, and/or ranges. Embodiments include receiving, from a database, one or more values corresponding to the parameters. The clinical status of the patient may be ascertained by determining whether one or more conditions are satisfied based on the parameter values. In embodiments, an indication of the clinical status is presented to the user.

Aspects of embodiments of the disclosure include a clinical decision support system that may provide enhanced situational awareness beyond existing patient monitoring capabilities by utilizing information from a greater diversity of data sources, thereby supporting a larger variety of parameter relationships. Embodiments of the disclosure may also contribute to improved clinical decisions and patient outcomes by providing clinicians the ability to configure parameter relationships of interest and configure alarming conditions. Embodiments of the disclosure may also facilitate improved assessment of changes in a patient's condition over time by providing an ability to specify and evaluate temporal relationships and trended parameter behaviors.

Certain embodiments of the disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

### BRIEF DESCRIPTION

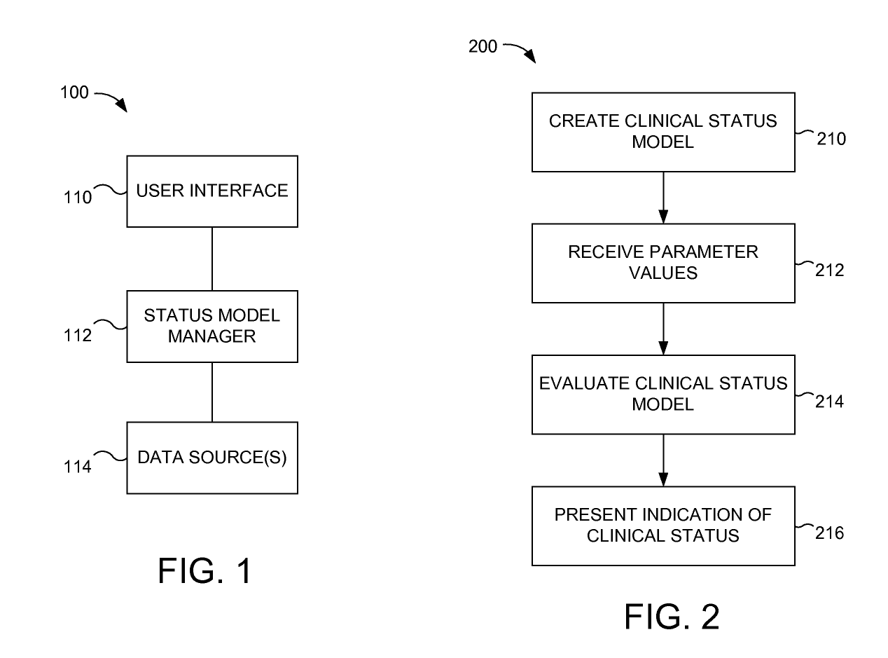

FIG. 1 is a block diagram depicting an illustrative clinical decision support system in accordance with embodiments of the disclosure;

FIG. 2 is a flow diagram depicting an illustrative method of determining a clinical status of a patient in accordance with embodiments of the disclosure;

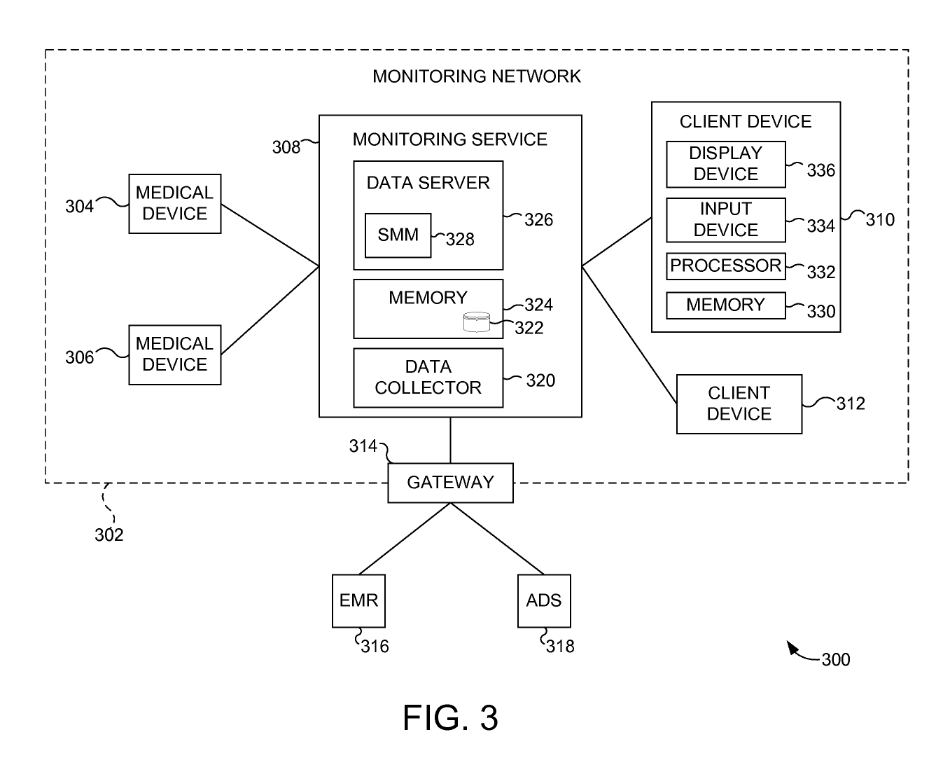

FIG. 3 is a block diagram depicting an illustrative patient monitoring system in accordance with embodiments of the disclosure;

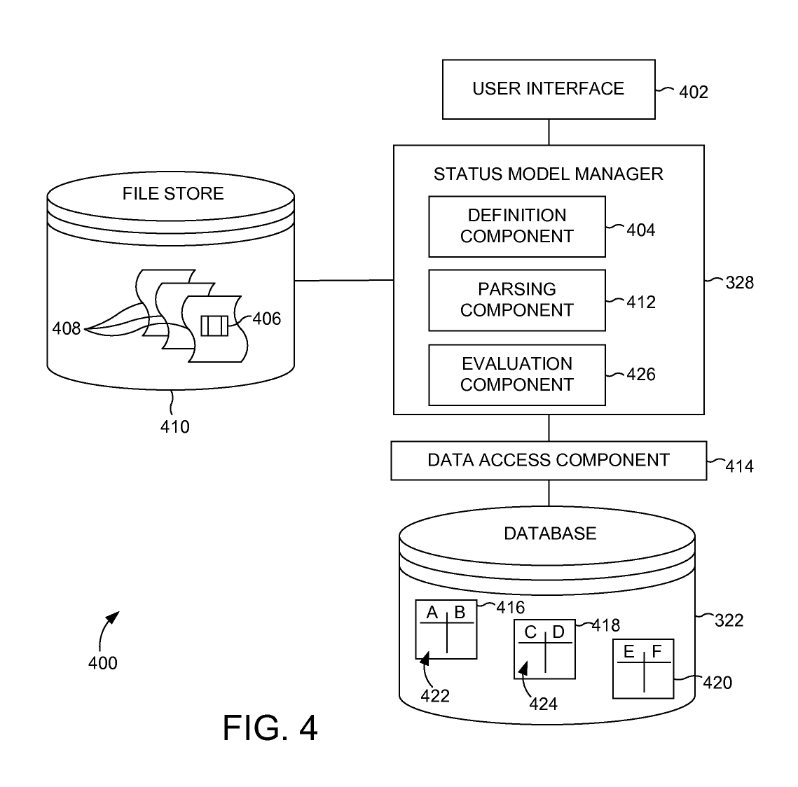

FIG. 4 is a block diagram depicting an illustrative operating environment in accordance with embodiments of the disclosure; and

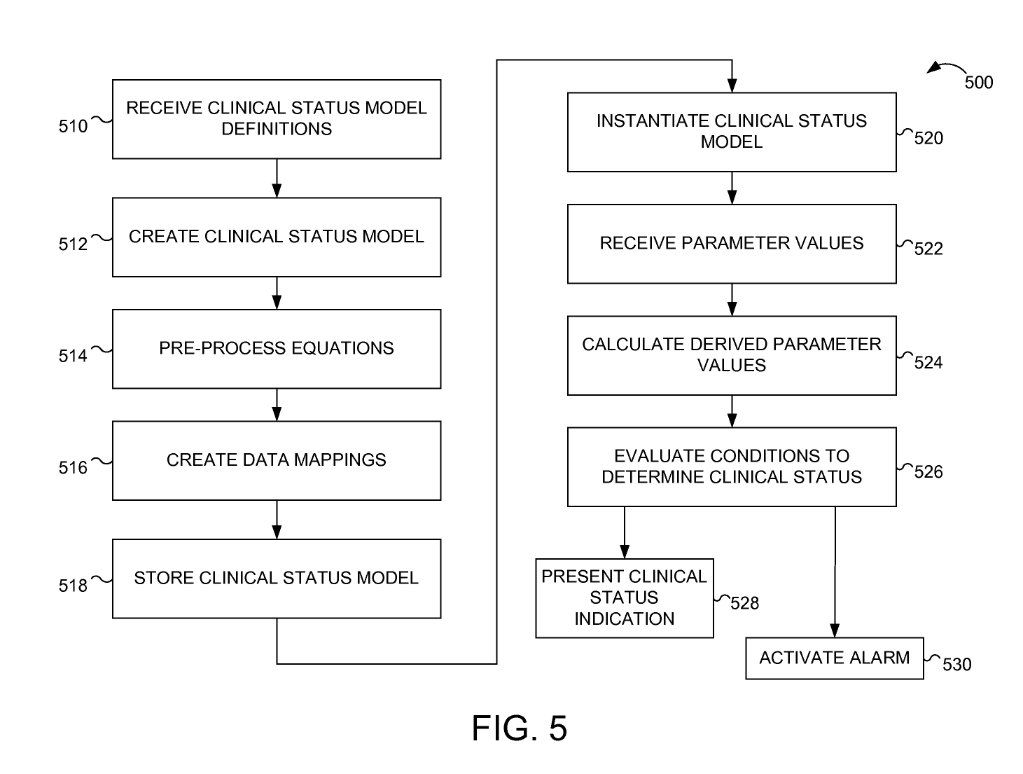

FIG. 5 is a flow diagram depicting an illustrative method of determining a clinical status of a patient in accordance with embodiments of the disclosure.

While the disclosed subject matter is amenable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the disclosure as defined by the appended claims.

### DETAILED DESCRIPTION

The subject matter of embodiments of the disclosure is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Moreover, although aspects of methods according to embodiments are described with reference to “blocks,” the term “block” should not be interpreted as implying any particular order among or between various aspects unless the order of individual aspects is explicitly described.

FIG. 1 is a block diagram depicting an illustrative clinical decision support system 100 that facilitates determining a clinical status of a patient. In embodiments, the system 100 includes user interface 110 that facilitates user interaction with status model manager (SMM) 112. SMM 112 may facilitate the creation, evaluation, and management of clinical status models that may be used for determining clinical statuses of patients. In embodiments, SMM 112 receives parameter values from one or more data sources 114 and determines a clinical status of a patient by evaluating a clinical status model, based on the received parameter values.

User interface 110 may include a text and/or graphical user interface operable to present clinical status indications via a display device (e.g., display device 336 shown in FIG. 3). Clinical status indications may include icons of different colors or shapes, flashing icons, colors, text, graphics, text messages, audible indications, and any other means for providing an indication of a clinical status of a patient. Alarms may include visual alarms and/or audible alarms. Additionally alarms may include alarm communications such as, for example, text messages, pages (e.g., using a paging system), emails, multimedia messages, and the like. User interface 110 may also be operable to allow a user to at least partially configure and manage clinical status models. For example, user interface 110 may also be operable to receive user input for defining conditions and clinical status models; selecting conditions and clinical status models; modifying conditions and clinical status models; and associating clinical status models with patients. In embodiments, for example, a clinical status model may be associated with a patient by identifying (e.g., by inputting, selecting, or the like) the patient, identifying (e.g., by inputting, selecting, or the like) the clinical status model, and creating an association between the patient and the clinical status model. In embodiments, associations between clinical status models and patients may be stored, for example, in a patient configuration file.

According to embodiments, data sources 114 may include, for example, databases, medical devices, electronic medical records, user interfaces, and the like. Medical devices may include therapy-providing devices (e.g., ventilators, infusion pumps, and the like), monitoring devices (e.g., pulse oximeters, capnography devices, multi-parameter patient monitors, ambulatory telemeters, and the like), or devices that combine therapy and monitoring functions. In embodiments, parameters may be received from any number of data sources.

Parameters may include physiological parameters, settings parameters, and derived parameters. Physiological parameters may include parameters measured, or otherwise obtained, by medical devices or clinicians; and settings parameters may include parameters corresponding to settings and/or protocols (e.g., monitoring protocols, treatement protocols, and the like) associated with medical devices. Exemplary physiological parameters include oxygen saturation (SpO2), pulse rate (PR), heart rate (HR), respiration rate (RR), exhaled minute volume (Ve), positive end-expiratory pressure (PEEP), tidal volume (Vt), and the like. Exemplary settings parameters include vent mode, inspiration pressure, target volume, flow pattern, spontaneous type, support pressure, sampling frequency, and the like. Derived parameters may include parameters that are calculated based on one or more physiological parameters, settings parameters, constants, and/or a combination of these. Exemplary derived parameters include tidal volume per ideal body weight (Vt/IBW), rapid shallow breathing index (RSBI), and the like.

In embodiments, the system 100 may facilitate creation of clinical status models. In embodiments, the clinical status models may be at least partially user-configurable, may be developed from published models, protocols, and the like. In embodiments, clinical status models may enable dynamic evaluation of multiple parameters and may support various mathematical functions (e.g., floor functions, statistical functions, and the like), evaluation of inequalities, multiple thresholds, and the like. Additionally, embodiments of the system 100 may facilitate evaluation of clinical status models using parameters that are indexed by time, evaluation of trend characteristics of one or more parameters, evaluation of time-determinant functions, and the like. According to embodiments, a clinical status model may correspond to a particular physiological process, treatment, monitoring procedure, or the like. Additionally, in embodiments, a clinical status model may correspond to multiple aspects, functions, procedures, and the like. For example, a clinical status model may correspond to an overall health and/or condition of a patient. Similarly, a clinical status of a patient may correspond to a single parameter, a general level of well-being, a particular output based on a protocol, an overall wellness measure, or the like.

Embodiments of the system 100 may facilitate evaluation of clinical statuses of multiple patients based on clinical status models that may include user-configurable conditions, multiple simultaneous conditions, and the like. In embodiments, a clinical status model may include one or more conditions, one or more protocols, settings associated with presenting clinical status indications, alarm settings, and the like. Evaluation of a clinical status model may include determining whether one or more of the conditions are satisfied. For example, a particular clinical status model might include three conditions. If all three conditions are satisfied, the clinical status might be a first clinical status; if none of the conditions are satisfied, the clinical status might be a second clinical status; if a first condition is satisfied, the clinical status might be a third clinical status; and so on. In embodiments, a clinical status model may facilitate determination of a number of clinical statuses of a patient.

In embodiments, various attributes may be associated with a clinical status model. Attributes may include, for example, a state, a priority or importance, a configurability level, a relationship with another clinical status model or models, and the like. For example, in embodiments a clinical status model in a first state might include a first set of conditions, protocols, or the like. Upon a determination (e.g., a determination that the patient has completed a particular stage of a breathing trial), the clinical status model may transition to a second state, in which the clinical status model includes a second set of conditions, protocols, or the like. In embodiments, a number of clinical status models may be ranked according to a clinical importance, prioritized, or the like. In embodiments, a clinical status model having a first configurability level may include conditions that cannot be configured or altered by a user, while a clinical status model having a second configurability level may include one or more conditions (or aspects of conditions or other features) that may be configured or altered. Additionally, in embodiments, a clinical status model may be related to one or more other clinical status models. For example, a first clinical status model might be instantiated based on a clinical status determination resulting from evaluation of a second clinical status model. As another example, a first clinical status model might transition from a first state to a second state based on a clinical status determination resulting from evaluation of a second clinical status model. In a further example, a number of clinical status models associated with different patients might be related to one another to facilitate performing an evaluation of patient care, monitoring, or other functions.

According to embodiments, a condition may include one or more relationships between one or more parameters and one or more thresholds and/or ranges. In embodiments, conditions may include, for example, mathematical expressions including one or more parameters, one or more operators, and one or more target values, thresholds and/or ranges. Operators may include Boolean operators, algebraic operators, arithmetic operators, statistical operators, and/or the like. For example, a condition may include an equality (i.e., equation) between a parameter and a target value (e.g., pulse rate equals 95). As another example, a condition may include an inequality between a parameter and a threshold and/or a range (e.g., pulse rate is less than 90; pulse rate is greater than 85 and less than 110, or the like). In embodiments, a condition may include a combination of equations and inequalities. Additionally, in embodiments, conditions may include other aspects such as temporal aspects (e.g., pulse rate is greater than 90 for at least three minutes), contextual aspects (e.g., pulse rate is greater than 90 when patient is at rest), relational aspects (e.g., pulse rate is greater than 90 while oxygen saturation is less than 85%), and/or the like. In embodiments, a condition may include a relationship between any number of parameters and any number of thresholds and/or ranges.

In embodiments, a patient may have, for example, a first clinical status if a condition is satisfied and a second clinical status if the condition is not satisfied. The determined clinical status or statuses of a patient or patients may be presented to a user, stored in a database, communicated to a remote device, and/or the like. Additionally, in embodiments, one or more alarms may be activated based on a clinical status. That is, in embodiments, an alarm might be activated in response to determining that the patient's clinical status is the first status. For instance, a condition might be satisfied when a patient's blood pressure exceeds a predetermined threshold at the same time that the patient's temperature exceeds another threshold. In that case, the patient's clinical status might be determined to be a first status, which may be associated with a label such as, for example, “critical” or “systemic failure,” and an alarm may be activated. In another example, a condition might be satisfied when a derived parameter (e.g., RSBI) is equal to a target value, is greater than a threshold, is less than a threshold, or is within a particular range. In further examples, a condition might be satisfied when a parameter first is equal to a target value, is greater than a threshold, is less than a threshold, or is within a particular range during a specified time period, when a parameter is equal to a target value, is greater than a threshold, is less than a threshold, or is within a particular range a specified number of times during a specified time period, when a parameter is equal to a target value, is greater than a threshold, is less than a threshold, or is within a particular range continuously for a specified time period, or the like.

In embodiments, a condition might be satisfied when values of one or more parameters are within one or more ranges of values. In embodiments, a condition might be satisfied, for example, when a value of a first parameter is within a first range and a value of a second parameter is within a second range. In embodiments, a condition might be satisfied when a set of parameters have values within a respective set of ranges, or the like. Any number of combinations of physiological parameters, derived parameters, parameters relationships, thresholds, ranges, and/or the like may be related to any number of conditions. Embodiments of the disclosure may facilitate user configuration of conditions, parameters, and the like. Embodiments may also facilitate user configuration of actions such as displaying indications of clinical status, activating alarms, and the like.

By providing dynamic, configurable, evaluation of multiple patients and parameters, embodiments of the system 100 may be used to facilitate identification of any number of various medical conditions and/or situations such as risk of lung injury (e.g., ventilator-induced lung damage), systemic failure (e.g., systemic inflammatory response syndrome, sepsis, and the like), a patient's readiness to be weaned off of a medical device such as a ventilator (e.g., by facilitating performance of a spontaneous breathing trial), and the like. Additionally, in embodiments, a user may select among various models during patient monitoring, thereby expanding the set of evaluation tools available to the user. For example, in embodiments, models may correspond to breathing stage protocols that can be selectively, successively, or simultaneously, evaluated during a spontaneous breathing trial.

FIG. 2 is a flow diagram depicting an illustrative method 200 of determining a clinical status of a patient. Embodiments of the method 200 include creating a clinical status model (block 210), which may be at least partially user-configured. Embodiments of the method 200 further include receiving parameter values (block 212). In embodiments, a state of the clinical status model may be determined, which may affect the selection of parameter values that are received. According to embodiments, parameter values may include values of physiological parameters, settings parameters, and/or derived parameters (e.g., equations). The parameter values may be received from any number of different data sources. Using the parameter values, the clinical status model may be evaluated to determine a clinical status of a patient (block 214), and an indication of the clinical status may be presented (block 216). In embodiments, a clinical status model may be evaluated in response to a user input; periodically such as, for example, at arbitrary intervals; or continuously.

FIG. 3 depicts an illustrative patient monitoring system 300 in accordance with embodiments of the disclosure. The patient monitoring system 300 includes a monitoring network 302 that may facilitate remote monitoring of patients (not shown). The monitoring network 302 may include any number of different medical devices 304 and 306 which are communicatively coupled to a monitoring service 308. In embodiments, the medical devices 304 and 306 can include, for example, therapy-providing devices (e.g., ventilators, infusion pumps, and the like) and monitoring devices (e.g., pulse oximeters, capnography devices, multi-parameter patient monitors, ambulatory telemeters, and the like). The monitoring service 308 may communicate with a number of client devices 310 and 312 to facilitate remote monitoring and analysis.

Various components of the monitoring network 302 such as, for example, the medical devices 304 and 306, the monitoring service 308, and client devices 310 and 312, may be communicatively coupled according to any number of arrangements using networking technology. Such networking technology may include, for example, hardwired network communications, wireless network communications, or a combination thereof. In embodiments, a gateway 314 allows the monitoring service 308 to access other networks and systems such as, for example, an electronic medical records (EMR) system 316, a patient admit/discharge system (ADS) 318, hospital networks (not shown), the internet (not shown), and the like.

In embodiments, the monitoring service 308 may include one or more computing devices and can be implemented using distributed computing technologies, failover arrangements, and the like. As shown in FIG. 3, the monitoring service 308 may include a data collector 320 that receives parameter values from medical devices 304 and 306. The data collector 320 may passively listen for data communications from the medical devices 304 and 306, actively poll the medical devices 304 and 306 for data, or a combination of the foregoing. In embodiments, the data collector 320 may be configured to communicate with any number of different types of medical devices 304 and 306 and can receive any number of different types of parameter data (e.g., values).

In embodiments, the data collector 320 may include translation mechanisms that facilitate storing received parameter values in a database 322, which is maintained in a memory 324. According to embodiments, the database 322 may be a relational database, one or more tables, a data cube or the like. The memory 324 may include one or more devices for storing data. The database 322 may support a query mechanism such as, for example, structured query language (SQL), online analytical processing (OLAP), or the like. In embodiments, the database 322 may include data received from other networks and systems such as, for example, an electronic medical records (EMR) system 316, a patient admit/discharge system (ADS) 318, and the like.

In embodiments, the monitoring service 308 includes a data server 326 that provides data services to the client devices 310 and 312. In embodiments, for example, the data server 326 may be a web server that provides a web page, an application server that hosts an application service, or a combination of these. In embodiments, the data server 326 may receive parameter values from the database 322 and provide the values to the client devices 310 and 312, for example, in response to requests from the client devices 310 and 312.

As illustrated, the data server 326 may also include a status model manager (SMM) 328. In embodiments, the SMM 328 facilitates determining a clinical status of a patient by facilitating the creation and evaluation of clinical status models. The SMM 328 may include software that may be hosted by the data server 326 or distributed between the data server 326 and the client devices 310 and 312. For example, in embodiments, the SMM 328 may include an application service having a server component executing on the data server 326 and a client component executing on a client device 310 and/or 312. In another embodiment, the SMM 328 may reside on a client device 310 or 312 and be configured to receive parameter values from the data server 326. In other embodiments, the SMM 328 may be hosted by any number of other computing devices in communication with the monitoring service 308 and/or the client devices 310 and 312.

In embodiments, the client devices 310 and 312 may be computing devices such as, for example, desktop computers, terminals, laptops, personal digital assistants (PDAs), mobile communications devices, or the like. In embodiments, a client device 310 may include a memory 330, a processor 332, an input device 334, and a display device 336. According to embodiments, the processor 332 (or processors) reads data from various entities such as a memory 330, the input device 334, and the like. In embodiments, the input device 334 may be used, for example, to receive input from a user such as clinical status model definitions, parameter values, commands, and the like. The display device 336 may be used, for example, to display clinical status indications, visual alarms, a user interface (e.g., the user interface 402 described below with reference to FIG. 4), and the like. In embodiments, the display device 336 and the input device 334 may be portions of a single device such as, for example, a touch-screen device. Any number of additional components, different components, and/or combinations of components can also be included in a computing device such as client device 310. Although the foregoing description describes exemplary computing devices with reference to the client device 310 illustrated in FIG. 3, the description may be similarly applicable to any number of other types of computing devices contemplated herein such as, for example, computing devices associated with the medical devices 304 and 306, the monitoring service 308, and the like.

In embodiments, the memory 324 and/or the memory 330 (or similar memory component associated with a computing device) can include computer-readable media. Computer-readable media include both volatile and non-volatile media, removable and nonremovable media, and contemplate media readable by a database, a processor, a router, and various other networked devices. By way of example, and not limitation, computer-readable media can include media implemented in any method or technology for storing information. Examples of stored information include computer-executable instructions, data structures, program modules, and other data representations. Media examples include, but are not limited to, Random Access Memory (RAM); Read Only Memory (ROM); Electronically Erasable Programmable Read Only Memory (EEPROM); flash memory or other memory technologies; Compact Disc Read-Only Memory (CD-ROM), digital versatile disks (DVDs) or other optical or holographic media; magnetic cassettes, magnetic tape, magnetic disk storage or other magnetic storage devices; data transmissions; or any other medium that can be used to encode information and can be accessed by a computing device such as, for example, quantum state memory, and the like.

The illustrative patient monitoring system 300 shown in FIG. 3 is not intended to suggest any limitation as to the scope of use or functionality of embodiments disclosed throughout this document. Neither should the illustrative system 300 be interpreted as having any dependency or requirement related to any single component or combination of components illustrated therein. For example, in some embodiments, the illustrative system 300 can include additional or fewer components. Additionally, any one or more of the components depicted in FIG. 3 can be, in various embodiments, integrated with any one or more of the other components depicted therein (or components not illustrated). Any number of other components or combinations of components can be integrated with the illustrative system depicted in FIG. 3, all of which are considered to be within the ambit of the disclosure.

Embodiments of the disclosed subject matter may be described in the general context of computer-executable instructions (e.g., software). Computer-executable instructions may include, for example, computer code, machine-useable instructions, and the like such as, for example, program components, capable of being executed by one or more processors associated with a computing device. For example, program components may include components of an operating environment such as, for example, the illustrative operating environment 400 described below with reference to FIG. 4. Generally, program components including routines, programs, objects, modules, data structures, portions of one or more of the preceding, and the like, refer to code that, when executed, causes a computing device to perform particular tasks (e.g., methods, calculations, etc.) or implement or manipulate various abstract data types. Some or all of the functionality contemplated herein may also be implemented in hardware, firmware, or some combination of software, hardware, and/or firmware.

FIG. 4 depicts an illustrative operating environment 400 in accordance with embodiments of the disclosure. As shown, the illustrative operating environment 400 may include the status model manager (SMM) 328 with which a user can interact via a user interface 402 to configure clinical status models, request model evaluations, view presentations of clinical status indications and/or alarms, and the like. In embodiments, the user interface 402 may be presented on a display device 336 of a client device, a display device (not shown) associated with the monitoring service 308, a display device associated with a medical device 304 or 306, or the like. Additionally, the user interface 402 may receive user input via an input device 334.

As shown in FIG. 4, the SMM 328 may include a definition component 404. For example, in embodiments, a user can provide clinical status model definitions to the definition component 404, which may use those definitions to create a clinical status model 406. Clinical status models 406 may be contained in configuration files 408 (e.g., “.dll” files, “.xml” files, or the like), which may be stored in a file store 410. Clinical status model definitions may include, for example, definitions of parameter relationships (e.g., equations), definitions of derived parameters, specifications of variables and/or constants, definitions of conditions, definitions of thresholds and/or ranges, specifications of time periods and/or trend characteristics, protocols, and the like. In embodiments, a user may provide an entire clinical status model definition, a portion of a clinical status model definition, or none of a clinical status model definition (e.g., in a case in which a clinical status model is pre-defined).

The SMM 328 may also include a parsing component 412 that parses the clinical status model 406 (or portions thereof) to facilitate pre-processing and/or evaluation of the clinical status model 406. For example, in embodiments, the clinical status model 406 can be pre-processed to identify common terms throughout multiple equations, conditions, or the like. Additionally, pre-processing may include performing constant folding and other techniques for facilitating efficient calculation and evaluation. The parsing component 412 may also identify variables defined within the clinical status model 406 that correspond to parameters that may be stored in a database 322.

In embodiments, the SMM 328 may include, or interact with, a data access component 414, which facilitates access to the database 322. In embodiments, for example, the data access component 414 may provide data mappings between variables in a clinical status model 406 and parameter values stored in the database 322, thereby facilitating automatic and dynamic retrieval of parameter values during evaluation of the clinical status model 406. In embodiments, the data access component 414 locates parameter values in the database 322, maps those values to variables contained in a clinical status model 406, and, during evaluation of the clinical status model 406, facilitates retrieval of the values (e.g., most recent values, historical values, and the like). According to embodiments, the data access component 414 may facilitate access, by the SMM 328, to parameter values from other data sources such as, for example, the data collector 320, medical devices 304 and 306, the user interface 402, the EMR system 316, the ADS system 318, and/or the like.

In embodiments, parameter values may be stored in various tables 416, 418, and 420 contained in the database 322. The data access component 414 may, in embodiments, identify, based on data mappings, which tables 416, 418, and 420 to query during evaluation. In this manner, unnecessary querying of tables 416, 418, or 420 may be avoided. For example, in an embodiment, a clinical status model 406 might include a definition of a derived parameter “X” that is defined by a relationship between a first physiological parameter, “A,” and a second physiological parameter, “C” (e.g., A+C=X). In the example, as values of the first physiological parameter, “A,” are collected, they may be stored in a column 422 of table 416; and, as values of the physiological parameter, “C,” are collected, they may be stored in a column 424 of table 418. In this example, the data access component 414 identifies the tables 416 and 418 that include the patient parameters, “A” and “C,” and stores some indication (e.g., in the clinical status model 406, internally, or the like) of the tables 416 and 418 that contain values corresponding to the parameters, “A” and “C,” so that other tables 420 are not queried for these values during evaluation of the clinical status model 406.

In embodiments, the data access component 414 also may manage prioritizing data sources associated with physiological parameters. In embodiments, for example, two or more different medical devices may provide values for a particular physiological parameter. For example, values of a respiration rate parameter corresponding to a particular patient may be received from a ventilator and a pulse oximeter, but the values received from the ventilator may tend to be more accurate as they are a direct measurement of respiration rate, whereas the values obtained from the pulse oximeter are calculated based on a plethysmograph and, as such, are an indirect measurement. In embodiments, the data access component 414 may be configured to map a corresponding variable in a model 406 to the values for respiration rate obtained by the ventilator rather than the pulse oximeter. Additionally, in embodiments, the data access component 414 may be configured to maintain an order of preference for retrieving the values so that, if values for a parameter are not available from a first medical device (e.g., a preferred data source), such as in a case in which the first medical device is not providing values (e.g., is not connected to the patient, is offline, or the like), the data access component 414 may retrieve values collected from a second medical device. Any number of medical devices may be included in such an order of preference. In embodiments, the data access component 414 may configure an order of preference based on automatic default preferences, user preferences, or other factors such as, for example, consistency of value measurement, network connectivity, signal quality, and/or the like.

According to embodiments, the user interface 402, the definition component 404, the parsing component 412, and the data access component 414 may work together to create a configuration file 408 containing a clinical status model 406. In embodiments, the configuration file 408 may include various types of information. Exemplary information included in a configuration file 408 may include a file name, a clinical status model 406, parameter names, an identification of each database table corresponding to a variable (e.g., parameter), an identification of each database column corresponding to a variable (e.g., parameter), an identification of each database field corresponding to a variable, a data source preference order, definitions of constants, and the like.

As shown in FIG. 4, the SMM 328 may include an evaluation component 426 that receives parameter values and evaluates clinical status models 406 based on the received values. In embodiments, the evaluation component 426 receives parameter values via the data access component 414, which may include a query engine (not shown) for querying the database 322. According to embodiments, the data access component 414 may determine, by referencing the database 322, that certain parameter values are not being received into the database 322 from a medical device. For example, a particular medical device may not be measuring parameter values or communicating parameter values for storage in the database (e.g., the medical device may not be connected to the network). In embodiments, the user may be prompted to input the parameter values, specify parameter values for replacement, modify the clinical status model, or the like.

In operation, a user may instantiate a particular clinical status model 406 by providing an input to the user interface 402, thereby causing the SMM 328 to load the corresponding configuration file 408. In embodiments, the parsing component 412 may perform further parsing operations on the clinical status model 406 during runtime to further facilitate evaluation of the model 406. The evaluation component 426 receives parameter values corresponding to variables defined in the model (e.g., from the database 322, the user interface 402, and the like) and evaluates equations, conditions, and the like that are defined in the model 406. In embodiments, the user may configure, at runtime, the evaluation process by, for example, specifying time periods of interest, requesting trend information, modifying or selecting conditions and/or thresholds, specifying data sources, specifying presentation options for displaying status indicators, specifying alarm mechanisms, and the like.

According to embodiments, various components of the operating environment 400 can be implemented on one or more computing devices that are communicatively coupled to one or more other computing devices such as through a network 302. According to embodiments, a computing device can include any type of computing device suitable for implementing embodiments of the disclosed subject matter. Examples of computing devices include terminals, workstations, servers, laptops, desktops, tablet computers, hand-held devices, wearable devices, implantable devices, and the like, all of which are contemplated within the scope of FIG. 4 and reference to various components of the operating environment 400. In embodiments, components of the operating environment 400 can include more than one computing device such as, for example, in a distributing computing environment, a networked environment, and the like. For example, in embodiments, components(or portions thereof) of the SMM 328 may be hosted on a computing device associated with a monitoring service 308, while other portions may be hosted on a handheld device, laptop, or other computing device such as, for example, a client device 310.

The illustrative operating environment 400 shown in FIG. 4 is not intended to suggest any limitation as to the scope of use or functionality of embodiments disclosed throughout this document. Neither should the illustrative operating environment 400 be interpreted as having any dependency or requirement related to any single component or combination of components illustrated therein. For example, in some embodiments, the illustrative operating environment 400 can include additional or fewer components. Additionally, any one or more of the components depicted in FIG. 4 can be, in various embodiments, integrated with any one or more of the other components depicted therein (and/or components not illustrated). Any number of other components or combinations of components can be integrated with the illustrative operating environment depicted in FIG. 4, all of which are considered to be within the ambit of the disclosure.

FIG. 5 is a flow diagram depicting an illustrative method 500 of determining a clinical status of a patient in accordance with embodiments of the disclosure. Embodiments of the method 500 include receiving clinical status model definitions from a user (block 510). In embodiments, a user may provide, via a user interface (e.g., user interface 402), definitions associated with various portions of a clinical status model such as, for example, conditions, equations, thresholds, and the like. A status model manager (e.g., SMM 328) creates a clinical status model that facilitates determining a clinical status of a patient (block 512). In embodiments, the clinical status model may include one or more parameter relationships (e.g., equations) and/or one or more conditions associated with one or more parameters. As described above, a condition may include a relationship between a parameter and a threshold value, a relationship between multiple parameters, a relationship between multiple parameters and one or more threshold values, and the like.

Embodiments of the method 500 include pre-processing equations (block 514) and creating data mappings (block 516) between variables and parameter value fields in a database (e.g., database 322). As shown in FIG. 5, the clinical status model may be stored as a configuration file (block 518). In embodiments, the clinical status model may be retrieved from storage to facilitate modification, review, replacement, and the like. Embodiments of the method 500 further include instantiating the clinical status model (block 520). According to embodiments, the clinical status model may be run in a continuous or quasi-continuous manner, for example, as part of a patient monitoring paradigm. In embodiments, the clinical status model may be instantiated in response to an action or communication by a user, a computing device, a software process, a clinical status determined using a different model, and/or the like. Additionally, in embodiments, the SMM may determine or set a state of the clinical status model.

In embodiments, the SMM receives parameter values (block 522), which may include physiological parameter values and/or settings parameter values. In embodiments, the parameter values may be received from any number of data sources such as, for example, a database, a medical device, a user, or the like. In embodiments, the parameter values can be used to calculate derived parameter values (block 524). According to embodiments of the method 500, the SMM uses the received (and/or calculated) parameter values to evaluate conditions defined in the clinical status model to determine a clinical status of the patient (block 526). For example, the clinical status may include a first status if a condition is satisfied and a second status if the condition is not satisfied. In embodiments, one or more conditions in a clinical status model may be weighted such that the clinical status determination is influenced to a greater or lesser degree based on the weighting. Additionally, in embodiments, evaluation of a clinical status model may provide information associated with a trend of one or more parameters. For example, the SMM may evaluate one or more conditions in relation to one or more sets of time-indexed values corresponding to one or more parameters. As is further shown in FIG. 5, an indication of the clinical status may be presented to a user (e.g., by displaying the indication on a display device such as the display device 336) (block 528). Additionally, one or more alarms may be activated based on the clinical status (block 530).

The disclosure has been described in relation to particular embodiments, which are intended in all respects to be illustrative rather than restrictive. Alternative embodiments will become apparent to those of ordinary skill in the art to which the disclosed subject matter pertains without departing from its scope. It will be understood that certain features and subcombinations are of utility and may be employed without reference to other features and subcombinations. This is contemplated by and is within the scope of the claims.

The following is claimed:

1. A method for using a computing device to determine a clinical status of a patient, the method comprising:
receiving, via an input device, at least a portion of a definition of a clinical status model from a user;
creating, using a processor, the clinical status model, wherein the clinical status model facilitates determining a clinical status of a patient, the clinical status model comprising at least one condition associated with at least one parameter, wherein the at least one condition comprises a relationship between the at least one parameter and at least one threshold value or at least one range of values;
receiving at least one value corresponding to the at least one parameter;
determining, using the processor, the clinical status of the patient by determining whether the at least one condition is satisfied based on the at least one value; and
presenting an indication of the clinical status on a display device.

2. The method of claim 21, wherein the clinical status comprises a first status if the at least one condition is satisfied and, wherein the clinical status comprises a second status if the at least one condition is not satisfied.

3. The method of claim 2, further comprising activating an alarm in response to determining that the clinical status comprises the first status.

4. The method of claim 21, wherein the at least one parameter comprises at least one of a physiological parameter, a settings parameter, and a derived parameter.

5. The method of claim 4, further comprising calculating the derived parameter by evaluating at least one equation, wherein the at least one equation includes a first variable corresponding to a first physiological parameter.

6. The method of claim 5, wherein the at least one equation includes a second variable corresponding to a second physiological parameter.

7. The method of claim 21, wherein the at least one value comprises a set of values corresponding to the at least one parameter, wherein each value of the set of values is indexed according to a measurement time, the measurement time comprising a time at which said value was determined.

8. The method of claim 7, further comprising evaluating the at least one condition for each of the set of values.

9. The method of claim 7, further comprising calculating a derived parameter value based on the set of values and evaluating the at least one condition for the derived parameter value.

10. A patient monitoring system comprising:
a monitoring service adapted to receive at least one value of at least one physiological parameter of a patient from at least one medical device, wherein the monitoring service facilitates determining a clinical status of the patient by evaluating a clinical status model based on the at least one value, wherein the clinical status model is at least partially configured by a user; and
a client device communicatively coupled to the monitoring service, the client device having a display device, wherein an indication of the clinical status of the patient is presented on the display device.

11. The system of claim 10, wherein the monitoring service comprises:
a data collector that receives the at least one value from the at least one medical device and stores the at least one value in the database;
a status model manager that receives the at least one value from the data collector or the database and determines the clinical status based on the at least one value.

12. The system of claim 11, wherein the status model manager is hosted by at least one of a web server and the client device.

13. The system of claim 11, the clinical status model comprising at least one condition associated with the at least one physiological parameter, wherein the at least one condition comprises a relationship between the at least one physiological parameter and at least one threshold value.

14. The system of claim 13, wherein evaluating the clinical status model comprises determining whether the at least one condition is satisfied based on the at least one value, wherein the clinical status comprises a first status if the at least one condition is satisfied and, wherein the clinical status comprises a second status if the at least one condition is not satisfied.

15. The system of claim 14, wherein the at least one value comprises a set of values corresponding to the at least one parameter, wherein each value of the set of values is indexed according to a measurement time, the measurement time comprising a time at which said value was determined.

16. The system of claim 15, wherein evaluating the clinical status model comprises calculating a derived parameter value based on the set of values and evaluating the at least one condition for the derived parameter value.

17. One or more non-transitory computer-readable media having computer-executable instructions embodied thereon for determining a clinical status of a patient, the instructions comprising:
a status model manager that receives at least one parameter value from a data source and determines the clinical status by evaluating a clinical status model based on the at least one value, wherein the clinical status model is at least partially configured by a user; and
a user interface that receives, from the user, a definition of at least a portion of the clinical status model and that presents an indication of the clinical status of the patient.

18. The media of claim 17, wherein the data source comprises at least one of a database, a medical device, and an electronic medical record.

19. The media of claim 18, further comprising a data access component that creates a mapping between the clinical status model and a field in a database in which the at least one parameter value is stored.

20. The media of claim 18, the status model manager comprising:
a definition component that creates the clinical status model; and
an evaluation component that evaluates the clinical status model based on the at least one value.

21. The method of claim 1, wherein the receiving at least one value corresponding to the at least one parameter is performed by a data collector that receives the at least one value and stores the at least one value in a database, and wherein determining, using the processor, the clinical status of the patient is performed by a status model manager that receives the at least one value from at least one of the data collector and the database.

22. The method of claim 1, wherein receiving, via an input device, at least a portion of a definition of a clinical status model from a user comprises receiving the at least one condition.

23. The system of claim 13, wherein the monitoring service is configured to enable the user to determine the at least one condition in the clinical status model.
